(19) United States
(12) Patent Application Publication
(10) Pub. No.: US 2026/0325947 A1
(43) Pub. Date: Oct. 22, 2026

(54) MULTI-MATERIAL SKATEBOARD DECK

(71) Applicant: KARSTEN MANUFACTURING CORPORATION, Phoenix, AZ (US)

(72) Inventors: Jordan D. Shoenhair, Scottsdale, AZ (US); Clayson C. Spackman, Scottsdale, AZ (US); John A. Solheim, Phoenix, AZ (US)

(73) Assignee: KARSTEN MANUFACTURING CORPORATION, Phoenix, AZ (US)

(21) Appl. No.: 19/650,162

(22) Filed: Apr. 16, 2026

Related U.S. Application Data
(60) Provisional application No. 63/790,640, filed on Apr. 17, 2025.

(51) Int. Cl. A63C 17/01; B32B 3/26; B32B 5/02; B32B 21/10

(52) U.S. Cl. CPC A63C 17/017; B32B 3/266; B32B 5/024; B32B 21/10; B32B 2250/05; B32B 2262/106; B32B 2307/7376

(57) ABSTRACT

A multi-material skateboard deck comprising fiber reinforced layers that provide structural support while improving the overall skateboard deck mass. The fiber reinforced layers are interspersed between other layers formed of wood and have a perimeter footprint that is smaller and entirely encompassed within the perimeter footprint of the wood layers.

### CROSS REFERENCE PRIORITIES

This claims the benefit of U.S. Provisional Application No. 63/790,640, filed Apr. 17, 2025, the contents of which are fully incorporated herein by reference.

### TECHNICAL FIELD

This disclosure relates generally to skateboards and, more particularly, relates to skateboard decks.

### BACKGROUND

Skateboard deck design must balance strength with weight of the skateboard deck. Overly heavy decks are cumbersome to ride. Historically, skateboard decks are formed of multiple layers of wood that are glued/epoxied together. More recently, skateboard decks may include a layer of non-wood material, such as fiber reinforced polymer material, that increases strength while reducing weight. A fiber reinforced polymer layer that is smaller than the dimensions of the surrounding wood layers create gaps that are filled with resin/epoxy and drastically increase the weight of the skateboard deck. Conversely, the manufacturing cost increases if the fiber reinforced polymer layer is the same shape as the skateboard deck.

### BRIEF DESCRIPTION OF THE DRAWINGS

To facilitate further description of the embodiments, the following drawings are provided in which:

FIG. 1 is a top plan view of a skateboard deck.

FIG. 2 is an exploded perspective view of the skateboard deck of FIG. 1.

FIG. 3 is a front elevation schematic view taken in cross section of the skateboard deck of FIG. 1.

FIG. 4 is a top plan view of a layer that is inset from a different layer of the skateboard deck of FIG. 1.

FIG. 5 is a top plan view of another layer that is inset from a different layer of the skateboard deck of FIG. 1.

FIG. 6 is a top plan view of another layer of the skateboard deck of FIG. 1.

FIG. 7 is a top plan view of another layer of the skateboard deck of FIG. 1.

FIG. 8 is a top plan view of another layer of the skateboard deck of FIG. 1.

FIG. 9 is a top plan view of another layer of the skateboard deck of FIG. 1.

FIG. 10 is a top plan view of another layer of the skateboard deck of FIG. 1.

### DEFINITIONS

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The term “geometric center” is defined as the geometric center of the skateboard deck when viewed from the top.

### DESCRIPTION

Described herein is a multi-material skateboard deck comprising fiber reinforced layers that provide sufficient structural support while maintaining the overall mass of the skateboard deck. The fiber reinforced layers are interspersed between other layers formed of wood and have a perimeter footprint that is smaller and entirely encompassed within the perimeter footprint of the wood layers. The multi-material skateboard deck embodiments described herein decrease the cost of manufacture, reduce or maintain the skateboard deck weight relative to the industry standard, increase the skateboard deck strength, and provide an aesthetic that is appealing to the rider.

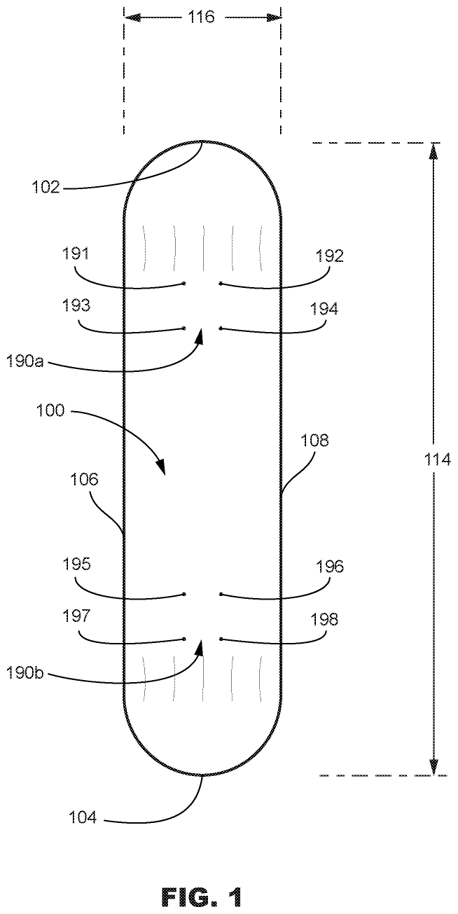

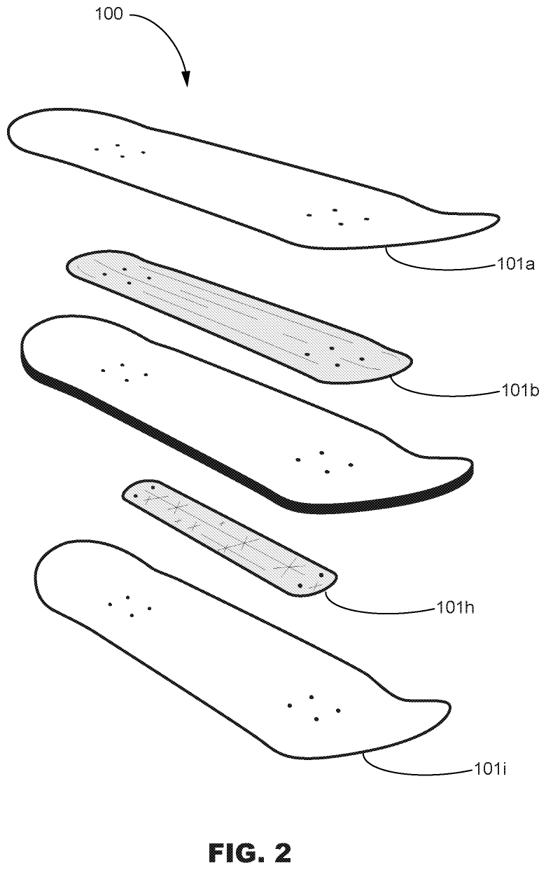

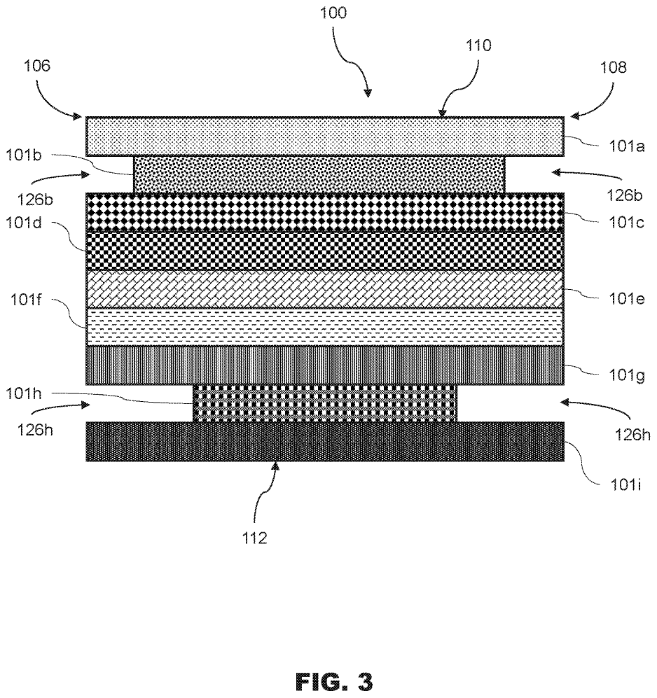

Different layer sizes and materials may be provided in a skateboard deck 100, as shown in FIGS. 1-10, to improve strength and torsional resistance while maintaining desirable weight properties. A skateboard deck 100 comprises a nose 102, a tail 104, a heel side 106, a toe side 108, a top surface 110, and a bottom surface 112. The top surface 110 receives a rider's feet and may include a piece of grip tape to improve friction between the rider's shoes and the skateboard deck 100. The heel side 106 and the toe side 108 are on opposite sides of the skateboard deck 100 and can be interchangeable depending on the rider's riding stance preference. The nose 102 is at the front of the skateboard deck 100 and the tail 104 is at the rear of the skateboard deck 100. The skateboard deck has a skateboard deck length 114, measured from the nose 102 to the tail 104 at the skateboard deck geometric center, and a skateboard deck width 116, measured from heel side 106 to toe side 108 at the skateboard deck 100 geometric center. The skateboard deck 100 can further comprise a front group of bolt holes 190a and a rear group of bolt holes 190b used to attach skateboard trucks. The front group of bolt holes 190a has a first bolt hole 191, a second bolt hole 192, a third bolt hole 193, and a fourth bolt hole 194. The rear group of bolt holes 190b has a fifth bolt hole 195, a sixth bolt hole 196, a seventh bolt hole 197, and an eighth bolt hole 198. The front and rear groups of bolt holes 190a, 190b are sized and arranged to match corresponding holes provided on a front and rear truck.

The skateboard deck comprises multiple layers to impart structural rigidity and durability. For example, the skateboard deck 100 may include a first layer 101a, a second layer 101b, a third layer 101c, a fourth layer 101d, a fifth layer 101e, a sixth layer 101f, a seventh layer 101g, an eighth layer 101h, and a ninth layer 101i. These layers are stacked on top of one another to form the skateboard deck. An epoxy resin is used to cure the different layers together.

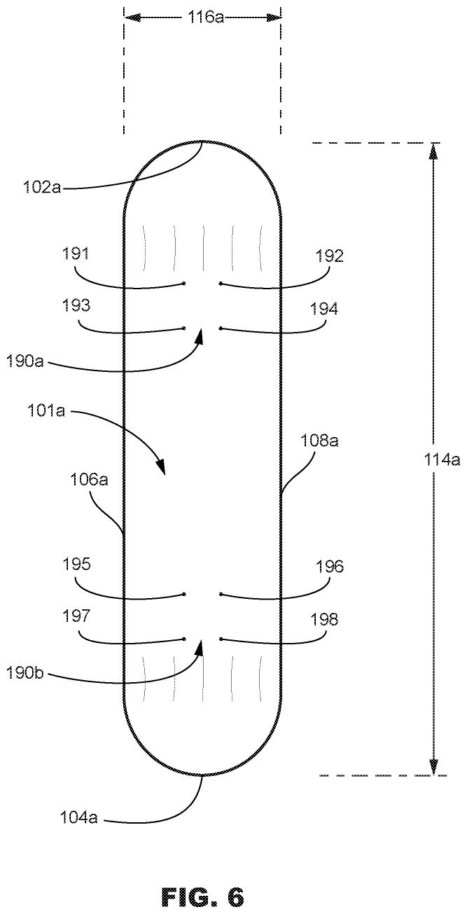

Each layer has regions similar to the overall deck layout described above. Accordingly, the first layer 101a has a first layer nose 102a, a first layer tail 104a opposite the first layer nose 102a, a first layer heel side 106a, a first layer toe side 108a opposite the first layer heel side 106a, a first layer length 114a, and a first layer width 116a, best illustrated in FIG. 6.

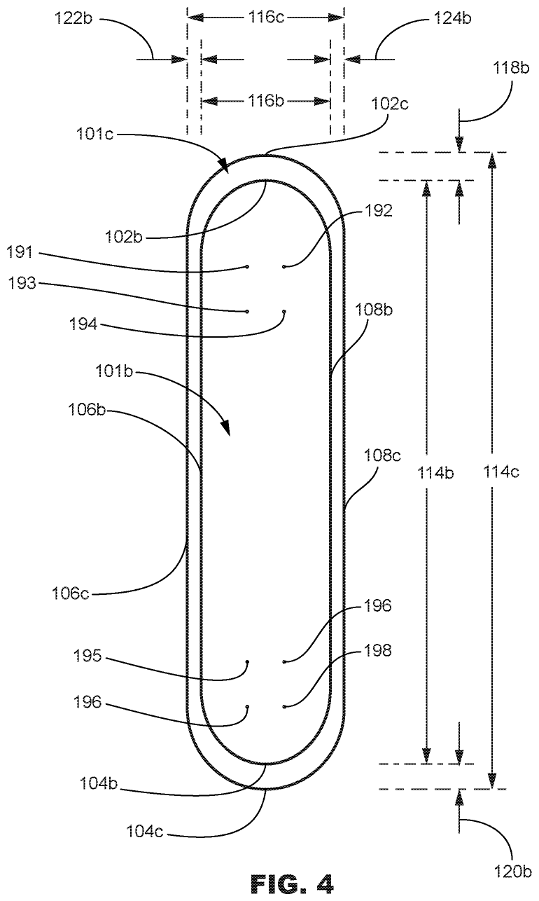

Similarly, The second layer 101b has a second layer nose 102b, a second layer tail 104b opposite the second layer nose 102b, a second layer heel side 106b, a second layer toe side 108b opposite the second layer heel side 106b, a second layer length 114b, and a second layer width 116b, best illustrated in FIG. 4.

The third layer 101c has a third layer nose 102c, a third layer tail 104c opposite the third layer nose 102c, a third layer heel side 106c, a third layer toe side 108c opposite the third layer heel side 106c, a third layer length 114c, and a third layer width 116c, best illustrated in FIG. 4.

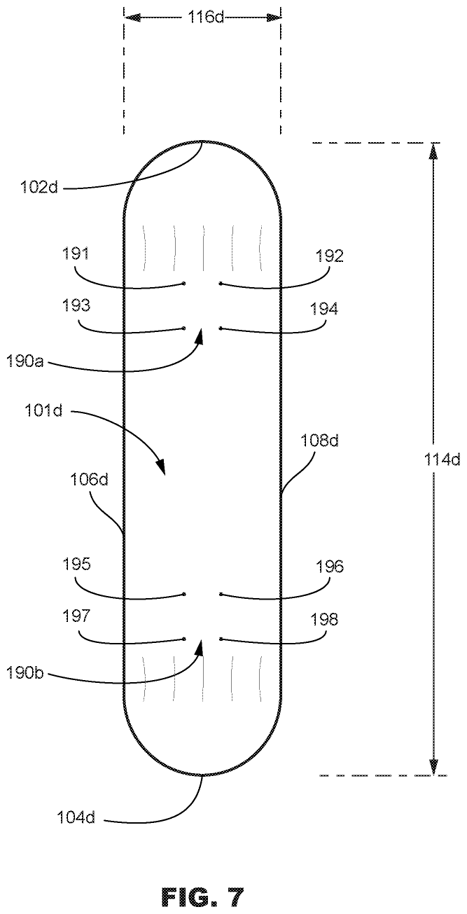

The fourth layer 101d has a fourth layer nose 102d, a fourth layer tail 104d opposite the fourth layer nose 102d, a fourth layer heel side 106d, a fourth layer toe side 108d opposite the fourth layer heel side 106d, a fourth layer length 114d, and a fourth layer width 116d, best illustrated in FIG. 7.

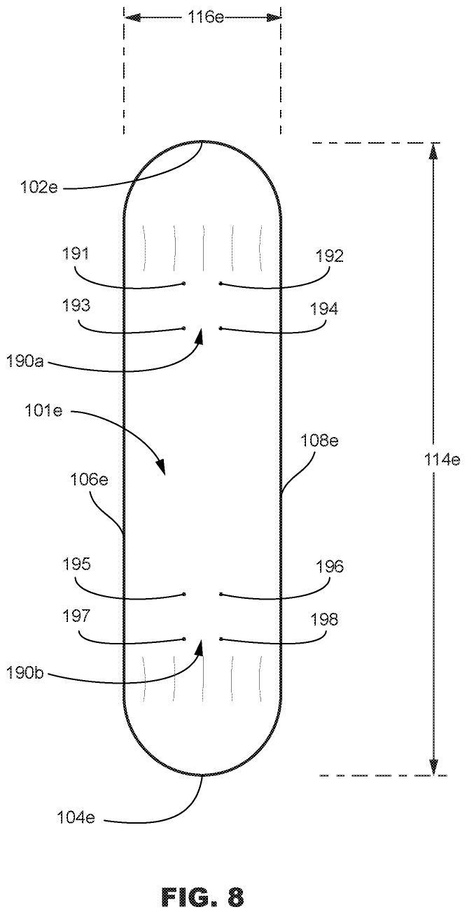

The fifth layer 101e has a fifth layer nose 102e, a fifth layer tail 104e opposite the fifth layer nose 102e, a fifth layer heel side 106e, a fifth layer toe side 108e opposite the fifth layer heel side 106e, a fifth layer length 114e, and a fifth layer width 116e, best illustrated in FIG. 8.

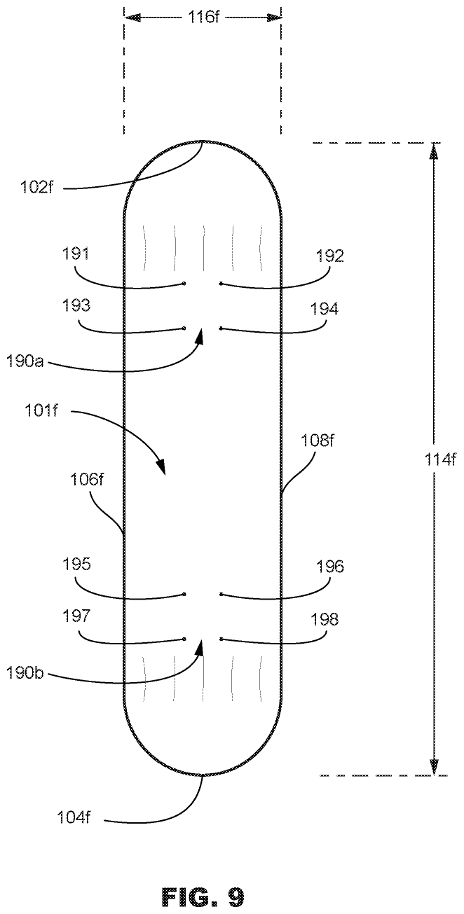

The sixth layer 101f has a sixth layer nose 102f, a sixth layer tail 104f opposite the sixth layer nose 102f, a sixth layer heel side 106f, a sixth layer toe side 108f opposite the sixth layer heel side 106f, a sixth layer length 114f, and a sixth layer width 116f, best illustrated in FIG. 9.

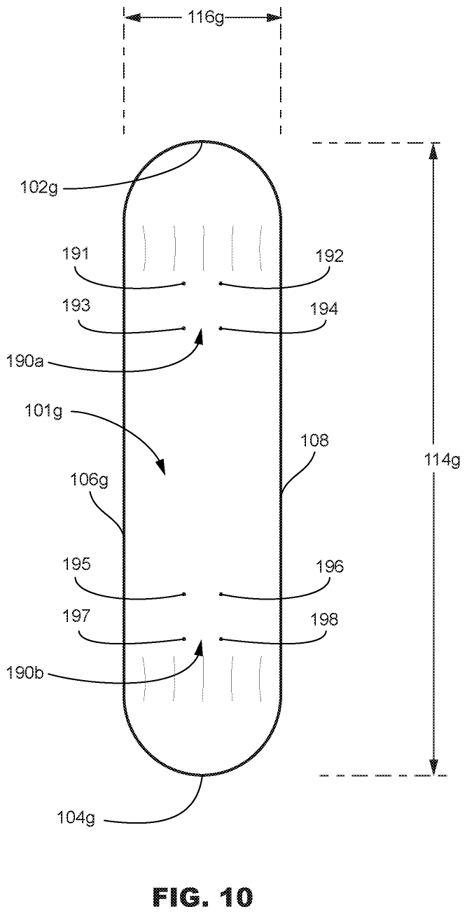

The seventh layer 101g has a seventh layer nose 102g, a seventh layer tail 104g opposite the seventh layer nose 102g, a seventh layer heel side 106g, a seventh layer toe side 108g opposite the seventh layer heel side 106g, a seventh layer length 114g, and a seventh layer width 116g, best illustrated in FIG. 10.

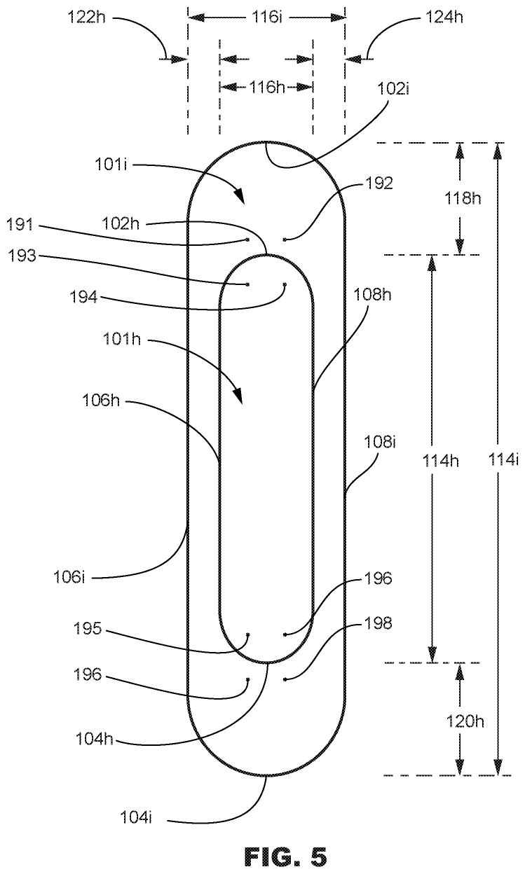

The eighth layer 101h has an eighth layer nose 102h, an eighth layer tail 104h opposite the eighth layer nose 102h, an eighth layer heel side 106h, an eighth layer toe side 108h opposite the eighth layer heel side 106h, an eighth layer length 114h, and an eighth layer width 116h, best illustrated in FIG. 5.

The ninth layer 101i has a ninth layer nose 102i, a ninth layer tail 104i opposite the ninth layer nose 102i, a ninth layer heel side 106i, a ninth layer toe side 108i opposite the ninth layer heel side 106i, a ninth layer length 114i, and a ninth layer width 116i, best illustrated in FIG. 5.

Certain of the layers are formed of wood and have a shape and size that matches the overall shape and size of the skateboard deck 100. The skateboard deck length 114, the first layer length 114a, the third layer length 114c, the fourth layer length 114d, the fifth layer length 114e, the sixth layer length 114f, the seventh layer length 114g, and the ninth layer length 114i are from 700 mm to 900 mm in length. In some embodiments, the skateboard deck length 114 is the same as the first layer length 114a, the third layer length 114c, the fourth layer length 114d, the fifth layer length 114e, the sixth layer length 114f, the seventh layer length 114g, and the ninth layer length 114i.

The skateboard deck width 116, the first layer width 116a, the third layer width 116c, the fourth layer width 116d, the fifth layer width 116e, the sixth layer width 116f, the seventh layer width 116g, and the ninth layer width 116i are from 160 mm to 270 mm in width. In some embodiments, the skateboard deck width 116 is the same as the first layer width 116a, the third layer width 116c, the fourth layer width 116d, the fifth layer width 116e, the sixth layer width 116f, the seventh layer width 116g, and the ninth layer width 116i.

Other layers are formed of a non-wood material having a relatively higher strength-to-weight ratio and therefore may have shapes and sizes that do not match the overall shape and size of the skateboard deck 100. For example, the second layer 101b is made from a first fiber reinforced polymer to add strength along the length of the skateboard deck, as best illustrated in FIG. 4. The second layer 101b is inset from the skateboard width and the skateboard length to reduce the amount of fiber reinforced polymer needed thereby reducing the mass added by the second layer 101b. The second layer length 114b is from 300 mm to 880 mm as opposed to the skateboard deck length 114 (700 mm to 900 mm). The second layer width 116b is from 50 mm to 260 mm as opposed to the skateboard deck width 116 (160 mm to 270 mm). The second layer 101b has a thickness from 0.1 mm to 0.25 mm. The second layer 101b has a second layer nose inset distance 118b from 10 mm to 300 mm. The second layer 101b has a second layer tail inset distance 120b from 10 mm to 300 mm. The second layer 101b has a second layer heel inset distance 122b from 10 mm to 110 mm. The second layer 101b has a second layer toe inset distance 124b from 10 mm to 110 mm. In some embodiments, the ratio of the second layer width 116b to the skateboard deck width 116 is from 0.5 to 0.9 thereby reducing the amount of fiber reinforced polymer improving strength and durability while maintaining desirable skateboard deck weight.

In some embodiments, the eighth layer 101h is made from a second fiber reinforced polymer to add torsional resistance and prevent breakage from the forces applied by the trucks and during use, as best illustrated in FIG. 5. The eighth layer 101h is inset from the skateboard width and the skateboard length to reduce the amount of fiber reinforced polymer needed thereby reducing the mass added by the eighth layer 101h. The eighth layer length 114h is from 300 mm to 880 mm as opposed to the skateboard deck length 114 (700 mm to 900 mm). The eighth layer width 116h is from 50 mm to 260 mm as opposed to the skateboard deck width 116 (160 mm to 270 mm). The eighth layer 101h thickness is from 0.25 mm to 0.35 mm. The eighth layer 101h has an eighth layer nose inset distance 118h from 10 mm to 300 mm. The eighth layer 101h has an eighth layer tail inset distance 120h from 10 mm to 300 mm. The eighth layer 101h has an eighth layer heel inset distance 122h from 10 mm to 110 mm. The eighth layer 101h has an eighth layer toe inset distance 124h from 10 mm to 110 mm. In some embodiments, the ratio of the eighth layer 101h width to the skateboard deck width 116 is from 0.35 to 0.65. The reduced width of the eighth layer 101h improves bonding and reduces mass, along with providing torsional resistance.

The layers of wood may have the same or different thicknesses. For example, the first layer 101a, the third layer 101c, the seventh layer 101g, and the ninth layer 101i have a thickness from 1 mm to 2 mm. The fourth layer 101d, the fifth layer 101e, and the sixth layer 101f have a thickness from 0.5 mm to 1.5 mm. The reduced layer thicknesses of the fourth layer 101d, the fifth layer 101e, and the sixth layer 101f retains a desirable mass by offsetting the mass added by the second layer 101b and the eighth layer 101h.

The lengths of the non-wood material layers maybe be selected to provide sufficient structural rigidity while reducing the amount of mass added to the deck. In some embodiments, the eighth layer 101h has only four bolt holes passing through it and more particularly the third bolt hole 193, the fourth bolt hole 194, the fifth bolt hole 195, and the sixth bolt hole 196 which are located closer to the skateboard deck geometric center. The eighth layer 101h provides torsional resistance to the board and decreases the amount of fiber reinforced polymer required, thereby reducing mass. Most torsional force is applied to the skateboard is from the inner four bolt holes (the third bolt hole 193, the fourth bolt hole 194, the fifth bolt hole 195, and the sixth bolt hole 196) and therefore is the region of the board that requires the most torsional reinforcement. In other embodiments, all eight bolt holes pass through the second layer 101b to transfer the forces from the skateboard deck to the trucks and vice versa.

In some embodiments, the eighth layer width 116h is at least 50 mm less than the skateboard deck width 116 to help the curing process. Since the second layer width 116b and the eighth layer width 116h are less than the skateboard deck width 116, there is a second layer gap 126b created between the first layer 101a and the third layer 101c and an eighth layer gap 126h the seventh layer 101g and the ninth layer. These gaps are only present in the layup process and do not exist in the final product. These gaps need to be filled when the board is cured, and the gap can either be filled by the first layer 101a, the third layer 101c, the seventh layer 101g, and the ninth layer 101i or by epoxy. However, if these gaps are filled with epoxy, the skateboard deck becomes heavy. Offsetting the edges of the eighth layer 101h and the second layer 101b allow the first layer 101a, the third layer 101c, the seventh layer 101g, and the ninth layer 101i to bend and fill this gap thereby reducing the amount of epoxy and thus decreasing the skateboard deck overall mass. This layup provides the requisite amount of epoxy within the second layer gap 126b and the eighth layer gap 126h, as the first layer 101a, the third layer 101c, the seventh layer 101g, and the ninth layer 101i are pressed within these gaps and thereby align with the second layer 101b and the eighth layer 101h to remove excess epoxy.

The first fiber reinforced polymer and the second fiber reinforced polymer can comprise different fiber weaves to accomplish different structural properties. These weaves can be a plain weave, a twill weave, a harness satin weave, a fish weave, a spread tow weave, a braided weave, a unidirectional weave, a triaxial weave, a custom weave, or any other suitable weave. In some embodiments, the first fiber reinforced polymer and the second fiber reinforced polymer have the same weave. In other embodiments, the first fiber reinforced polymer and the second fiber reinforced polymer have different weaves. In some embodiments, the first fiber reinforced polymer can comprise a unidirectional weave to add strength along the length of the skateboard deck and the second fiber reinforced polymer can comprise a triaxial weave to add torsional resistance.

The wood layers may be oriented to have wood grains running in different directions. For example, the first layer 101a, the third layer 101c, the fifth layer 101e, the seventh layer 101g, and the ninth layer 101i have a grain oriented from the nose to the tail to provide rigidity along the length of the board. This grain orientation, also known as a long-grain orientation, provides strength along the length of the board and improves the pop of the skateboard deck.

Additionally, in some embodiments, the fourth layer 101d and the sixth layer 101f can comprise a grain oriented from the heel side to the toe side to provide rigidity along the width of the board. This grain orientation, also known as a cross-grain structure, provides rigidity when the board undergoes torsional forces.

### Example I

Physical attributes, specifically the modulus of elasticity and yield force, were measured for the skateboard deck layups as described above. In a performance example, an exemplary skateboard deck layup coupon was compared to a control skateboard deck layup coupon to measure yield force and elasticity. Each coupon was submitted to a three-point bend test to measure and record the modulus of elasticity and yield force. Three different coupons of each of the exemplary skateboard deck layup and the control skateboard deck layup were submitted to the three-point bend test. All data points were averaged.

The exemplary skateboard deck layup coupon was similar to embodiment 100 described above having a first layer, a third layer, a seventh layer, and a ninth layer all made from wood, having a grain oriented from the nose to the tail, and having a thickness of 1.57 mm; a fourth layer and a sixth layer each made from wood, having a grain from the heel side to the toe side, and having a thickness of 1.14 mm; a fifth layer made from wood, having a grain oriented from the nose to the tail, and having a thickness of 1.14 mm; a second layer made from a fiber reinforced polymer having a unidirectional weave, and having a thickness of 0.15 mm; and an eighth layer made from a fiber reinforced polymer having a triaxial weave, and having a thickness of 0.30 mm (see summary table).

The control skateboard deck layup coupon had seven wood layers made up of: a first layer, a second layer, a fourth layer, a sixth layer, and a seventh layer having a grain oriented from the nose to the tail and a thickness of 1.57 mm; and a third layer and a fifth layer having a grain oriented from the heel side to the toe side having a thickness of 1.14 mm (see summary table).

Skateboard Deck Layup Coupon Summary Table

| | Exemplary Skateboard | | | Control Skateboard | | |
|---|---|---|---|---|---|---|
| | Deck Layup Coupon | | | Deck Layup Coupon | | |
| | | | Thick- | | | |
| | | Grain/ | ness | | Grain/ | Thick- |
| Layer | Material | Weave | [mm] | Material | Weave | ness |
| 1 | Wood | Nose to Tail | 1.57 | Wood | Nose to Tail | 1.57 |
| 2 | Fiber | Unidirec- | 0.15 | Wood | Nose to Tail | 1.57 |
| | Rein- | tional | | | | |
| | forced | | | | | |
| | Polymer | | | | | |
| 3 | Wood | Nose to Tail | 1.57 | Wood | Heel to Toe | 1.14 |
| 4 | Wood | Heel to Toe | 1.14 | Wood | Nose to Tail | 1.57 |
| 5 | Wood | Nose to Tail | 1.14 | Wood | Heel to Toe | 1.14 |
| 6 | Wood | Heel to Toe | 1.14 | Wood | Nose to Tail | 1.57 |
| 7 | Wood | Nose to Tail | 1.57 | Wood | Nose to Tail | 1.57 |
| 8 | Fiber | Triaxial | 0.30 | N/A | N/A | N/A |
| | Rein- | | | | | |
| | forced | | | | | |
| | Polymer | | | | | |
| 9 | Wood | Nose to Tail | 1.57 | N/A | N/A | N/A |

The exemplary skateboard deck layup coupon had an average modulus of elasticity of 11.71 ksi and an average yield force of 212.35 lbf. The control skateboard deck layup coupon had an average modulus of elasticity of 9.96 ksi and an average yield force of 170.04 lbf. The exemplary skateboard deck had a 1.75 ksi greater average modulus of elasticity and a 42.31 lbf greater average yield force, yielding an 18% gain in stiffness and a 25% gain in strength. This increase in stiffness and strength of the exemplary skateboard layup coupon demonstrated a greater durability while maintaining a desirable weight over the control skateboard deck layup coupon.

| Skateboard Deck Performance | Average Modulus of | Average Yield Force |
|---|---|---|
| Coupon Summary Table | Elasticity [ksi] | [lbf] |
| Exemplary Skateboard Deck | 11.71 | 212.35 |
| Layup Coupon | | |
| Control Skateboard Deck | 9.96 | 170.04 |
| Layup Coupon | | |
| Exemplary Layup | 1.75 | 42.31 |
| Coupon Gain | | |
| Exemplary Layup | 18% | 25% |
| Coupon % Gain | | |

### Example II

The mass of skateboard layups were recorded to show a mass savings for inset fiber reinforced polymer layers. The mass of an exemplary skateboard deck layup was compared to the mass of a control skateboard deck layup.

The exemplary skateboard deck layup was similar to embodiment 100 described above having a first layer, a third layer, a seventh layer, and a ninth layer all made from wood, having a grain oriented from the nose to the tail, and having a thickness of 1.57 mm; a fourth layer and a sixth layer each made from wood, having a grain from the heel side to the toe side, and having a thickness of 1.14 mm; a fifth layer made from wood, having a grain oriented from the nose to the tail, and having a thickness of 1.14 mm; a second layer made from a fiber reinforced polymer having a unidirectional weave, having a thickness of 0.15 mm, a second layer nose inset distance of 120.65 mm, a second layer tail inset distance of 120.65 mm, a second layer heel inset distance of 25.4 mm, and a second layer toe inset distance of 25.4; and an eighth layer made from a fiber reinforced polymer having a triaxial weave, having a thickness of 0.30 mm, an eighth layer nose inset distance of 120.65 mm, an eighth layer tail inset distance of 120.65 mm, an eighth layer heel inset distance of 25.4 mm, and an eighth layer toe inset distance of 25.4 mm (see summary table).

The control skateboard deck layup had a third layer, a fifth layer, and a ninth layer all made from wood, having a grain oriented from the nose to the tail, and having a thickness of 1.57 mm; a fourth layer and a sixth layer each made from wood, having a grain from the heel side to the toe side, and having a thickness of 1.14 mm; a second and a seventh layer made from wood, having a grain oriented from the nose to the tail, and having a thickness of 1.14 mm; and a first layer and an eighth layer made from a fiber reinforced polymer having a triaxial weave, and having a thickness of 0.3 mm (see summary table).

Exemplary Skateboard Deck Layup

| | | | | Heel and Toe | Nose and Tail |
|---|---|---|---|---|---|
| | | | Thickness | Inset Distance | Inset Distance |
| Layer | Material | Grain/Weave | [mm] | [mm] | [mm] |
| 1 | Wood | Nose to Tail | 1.57 | N/A | N/A |
| 2 | Fiber | Unidirectional | 0.15 | 25.4 | 120.65 |
| | Reinforced | | | | |
| | Polymer | | | | |
| 3 | Wood | Nose to Tail | 1.57 | N/A | N/A |
| 4 | Wood | Heel to Toe | 1.14 | N/A | N/A |
| 5 | Wood | Nose to Tail | 1.14 | N/A | N/A |
| 6 | Wood | Heel to Toe | 1.14 | N/A | N/A |
| 7 | Wood | Nose to Tail | 1.57 | N/A | N/A |
| 8 | Fiber | Triaxial | 0.30 | 25.4 | 120.65 |
| | Reinforced | | | | |
| | Polymer | | | | |
| 9 | Wood | Nose to Tail | 1.57 | N/A | N/A |

Control Skateboard Deck Layup Coupon

| | | | | Heel and Toe | Nose and Tail |
|---|---|---|---|---|---|
| | | | | Inset Distance | Inset Distance |
| Layer | Material | Grain/Weave | Thickness | [mm] | [mm] |
| 1 | Fiber | Triaxial | 0.3 | N/A | N/A |
| | Reinforced | | | | |
| | Polymer | | | | |
| 2 | Wood | Nose to Tail | 1.14 | N/A | N/A |
| 3 | Wood | Nose to Tail | 1.57 | N/A | N/A |
| 4 | Wood | Heel to Toe | 1.14 | N/A | N/A |
| 5 | Wood | Nose to Tail | 1.57 | N/A | N/A |
| 6 | Wood | Heel to Toe | 1.14 | N/A | N/A |
| 7 | Wood | Nose to Tail | 1.14 | N/A | N/A |
| 8 | Fiber | Triaxial | 0.3 | N/A | N/A |
| | Reinforced | | | | |
| | Polymer | | | | |
| 9 | Wood | Nose to Tail | 1.57 | N/A | N/A |

The exemplary skateboard deck had a mass of 1401.94 grams, and the control skateboard deck had a mass of 1439.35 grams. The inset fiber reinforced layers reduced the mass by 37.41 grams over the control skateboard having full length and width fiber reinforced layers. The reduced weight created a more agile board to perform skateboard tricks.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention.

1. A skateboard deck comprising:
a nose, a tail, a heel side, a toe side, a top surface, a bottom surface, a skateboard deck width, and a skateboard deck length;
a first layer, a second layer, a third layer, a fourth layer, a fifth layer, a sixth layer, a seventh layer, an eighth layer, and a ninth layer;
each of the first layer, the third layer, the seventh layer, and the ninth layer are made from a wooden material and comprise:
a width from 190 mm to 235 mm;
a length from 800 mm to 830 mm; and
a thickness from 1 mm to 2 mm;
each of the fourth layer, the fifth layer, and the sixth layer are made from a wooden material and comprise:
a width from 190 mm to 235 mm;
a length from 800 mm to 830 mm; and
a thickness from 0.5 mm to 1.5 mm;
the second layer is made from a first fiber reinforced polymer and comprises:
a width from 120 mm to 170 mm;
a length from 560 mm to 780 mm; and
a thickness from 0.1 mm to 0.25 mm;
the eighth layer is made from a second fiber reinforced polymer and comprises:
a width from 90 mm to 120 mm;
a length from 400 mm to 600 mm; and
a thickness from 0.25 mm to 0.35 mm.

2. The skateboard deck of claim 1, wherein the second layer comprises a unidirectional carbon fiber reinforced polymer material.

3. The skateboard deck of claim 2, wherein the eighth layer comprises a tri-axial woven carbon fiber reinforced polymer material.

4. The skateboard deck of claim 1, further comprising a ratio of a second layer width to the skateboard deck width is from 0.5 to 0.9.

5. The skateboard deck of claim 4, wherein the skateboard deck width is equal to a first layer width, a third layer width, a fourth layer width, a fifth layer width, a sixth layer width, a seventh layer width, and a ninth layer width.

6. The skateboard deck of claim 1, further comprising a ratio of an eighth layer width to the skateboard deck width is from 0.35 to 0.65.

7. The skateboard deck of claim 6, wherein the skateboard deck width is equal to a first layer width, a third layer width, a fourth layer width, a fifth layer width, a sixth layer width, a seventh layer width, and a ninth layer width.

8. The skateboard deck of claim 1, wherein an eighth layer width is at least 50 mm less than the skateboard deck width.

9. The skateboard deck of claim 1, wherein the first layer, the third layer, the fifth layer, the seventh layer, and the ninth layer comprise a grain oriented from the nose to the tail.

10. The skateboard deck of claim 9, wherein the fourth layer and the sixth layer comprise a grain oriented from the heel side to the toe side.

11. The skateboard deck of claim 1 further comprising a first bolt hole, a second bolt hole, a third bolt hole, a fourth bolt hole, a fifth bolt hole, a sixth bolt hole, a seventh bolt hole, and an eighth bolt hole.

12. The skateboard deck of claim 11 wherein the first bolt hole, the second bolt hole, the third bolt hole, the fourth bolt hole, the fifth bolt hole, the sixth bolt hole, the seventh bolt hole, and the eighth bolt hole pass through the second layer.

13. The skateboard deck of claim 12 wherein the third bolt hole, the fourth bolt hole, the fifth bolt hole, and the sixth bolt hole pass through the eighth layer and the first bolt hole, the second bolt hole, the seventh bolt hole, and the eighth bolt hole do not pass through the eighth layer.

14. The skateboard deck of claim 11 wherein the third bolt hole, the fourth bolt hole, the fifth bolt hole, and the sixth bolt hole pass through the eighth layer and the first bolt hole, the second bolt hole, the seventh bolt hole, and the eighth bolt hole do not pass through the eighth layer.
